(19) United States
(12) Patent Application Publication
(10) Pub. No.: US 2024/0046287 A1
(43) Pub. Date: Feb. 8, 2024

(54) SYSTEM AND METHOD UTILIZING MACHINE LEARNING TO PREDICT DROP-OFF OF USER ENGAGEMENT WITH EXPERT SYSTEMS

(71) Applicant: Million Doors, Inc., San Francisco, CA (US)

(72) Inventors: Craig M. TRIM, Ventura, CA (US); John Jien KAO, San Francisco, CA (US)

(21) Appl. No.: 18/364,775

(22) Filed: Aug. 3, 2023

Related U.S. Application Data
(63) Continuation of application No. PCT/US23/71529, filed on Aug. 2, 2023.
(60) Provisional application No. 63/370,344, filed on Aug. 3, 2022.

(51) Int. Cl. G06Q 30/0202; G06N 5/043

(52) U.S. Cl. CPC G06Q 30/0202; G06N 5/043

(57) ABSTRACT

Described herein are platforms, systems, media, and methods for predicting expert system user engagement, utilizing methodology comprising: applying an algorithm to analyze interaction patterns in the expert system and develop a graph model; performing randomized vectorization of a plurality of pre-selected metrics, wherein each vector has at least two metrics; developing a logistic activation function across the graph model using each vector to determine a baseline engagement and an engagement threshold for each user; and applying a machine learning algorithm to predict engagement movement for each user.

### CROSS-REFERENCE TO RELATED APPLICATIONS

This application is a continuation of International Application No. PCT/US2023/071529, filed Aug. 2, 2023, which claims the benefit of U.S. Provisional Application No. 63/370,344, filed on Aug. 3, 2022, each of which are incorporated by reference in their entirety.

### BACKGROUND

Customer engagement has never been more critical. As more consumers have moved online largely driven by the pandemic—businesses have had to transform their customer experience radically. Artificial Intelligence (AI) chatbots have risen to prominence, representing brands 24-hours-a-day and 7-days-a-week. Consumers expect brands to know them, anticipate their needs and interests, and serve only the content and products they want.

### SUMMARY

Customer engagement is interacting with customers through varied channels to develop and strengthen a relationship with them. Chatbots can allow customers to engage with a brand and get information and suggestion on products or services. A successful implementation can guide customers through the sales funnel with increased velocity while creating a positive brand experience with a customer engagement strategy. No more getting bogged down with repetitive tasks like waiting on hold or being directed from one department to another.

How a bot memorably communicates with a user is key to enhancing this feeling of caring and compassion. A critical aspect of branding involves creating an experience for your customer that makes them feel cared for and special. When users are happy with how easy a chatbot is to use, they're likely to recommend it to others and brand loyalty increases as a result. In addition, brand loyalty can decrease churn rates. Loyal customers tend to spend much more money than those who don't.

Naturally, just deploying a chatbot isn't enough. It is critical to monitor how the chatbot responds to customer queries and highlights any issues. Metrics guide behavioral development and help triage maintenance.

The current state of chatbot metrics and key performance indicators (KPIs) provide point-in-time statistics that determine how individual interactions are faring but do little to indicate engagement as either a time-series or predictive element.

When a chatbot implementation refers to self-learning, it generally appears to be some variation on a theme of what we describe here. Some implementations may be more or less efficient and effective than others, but this pattern applies: 1) Generation of a customized Engagement Threshold per consumer; and 2) Prediction of engagement drop-off by predicting movement on said threshold.

Referring to FIG. 2A, in some expert systems 200, a human initiates interaction with the system by asking a question 201. The system 200, receives the question 205 and first interprets the question intent 210 in order to find one or more best answers 215 by performing a search of one or more knowledge bases 220. After formulating an appropriate response 225, the system sends the response 230 to the human. Upon receiving the response 235, the human evaluates the response 240 and optionally provides feedback 245. If provided, the feedback is stored 250, optionally modified, and used to update the knowledge base 220.

Continuing to refer to FIG. 2A, in some systems 200, an item of metadata is attached to a question and answer pair (QA pair). The persistence of this metadata provides an opportunity for improvement. The system can either learn from this metadata in real time, near time, or offline. The offline method means a scheduled activity occurs independently of the runtime application. The planned action will analyze the metadata items. The outcome of the analysis may involve a model update. The model may be statistical or heuristic in nature. The updates may apply new heuristics (rules) or numerical updates to existing statistical formulas. When a user asks the same (or similar) question again, the system will take advantage of these model updates. Near time and Run time updating varies little from the offline approach, except in the amount of computational energy required to perform the updates quicker, rather than waiting for pre-defined windows.

We describe novel systems and methods for predicting individual and aggregated engagement thresholds. The metric described herein performs predictive guidance in the triage of critical resources to perform course correction in adverse situations and sustainability in positive scenarios. The subject matter described herein indicates whether the chatbot experience strengthens or weakens existing consumer relationships. The threshold activation function becomes a classifier for present engagement and a baseline for predicting future engagement. This novel solution can guide implementation on how best to triage critical resources to triage situations where the engagement prediction is negative and how to sustain and increase positive predictions.

Accordingly, in one aspect, disclosed herein are computer-implemented systems for predicting expert system user engagement, the system comprising at least one computing device comprising at least one processor and instructions executable by the at least one processor to perform operations comprising: applying an algorithm to analyze interaction patterns in the expert system and develop a graph model; performing randomized vectorization of a plurality of pre-selected metrics, wherein each vector has at least two metrics; developing a logistic activation function across the graph model using each vector to determine a baseline engagement and an engagement threshold for each user; and applying a machine learning algorithm to predict engagement movement for each user. In some embodiments, the expert system is part of an expert system network comprising a plurality of expert systems. In further embodiments, the algorithm to analyze interaction patterns operates across the expert system network. In further embodiments, the algorithm to analyze interaction patterns employs longitudinal probabilistic network analysis (PNA) to identify the patterns and trends of dynamics within the expert system network. In further embodiments, the machine learning algorithm predicts engagement movement for each user with one or more of the plurality of expert systems in the expert system network. In various embodiments, the interaction patterns are between users, between users and expert systems, between expert systems, or any combination thereof. In some embodiments, the graph model comprises time-series data. In various embodiments, the pre-selected metrics comprise one or more of: speed of response, conversational sentiment, dialogue complexity, response accuracy, and bounce rate. In some embodiments, the randomized vectorization comprises a combinatorial process. In further embodiments, the combinatorial process comprises partial differentiation. In some embodiments, each vector forms a multi-dimensional point-in-time engagement metric. In some embodiments, the logistic activation function comprises a non-linear function. In some embodiments, the logistic activation function comprises a learned distribution function for overall negative engagement and overall positive engagement. In some embodiments, the operations further comprise applying an algorithm to perform a combinatorial analysis of the variables to determine relationships and groupings. In some embodiments, the operations further comprise performing a course correction action when the predicted engagement movement is negative. In some embodiments, the operations further comprise performing a sustainability action when the predicted engagement movement is positive. In some embodiments, the logistic activation function determines a baseline engagement and an engagement threshold for users in aggregate. In further embodiments, the machine learning algorithm predicts engagement movement for users in aggregate.

In another aspect, disclosed herein are computer-implemented methods of predicting expert system user engagement, the method comprising: applying an algorithm to analyze interaction patterns in the expert system and develop a graph model; performing randomized vectorization of a plurality of pre-selected metrics, wherein each vector has at least two metrics; developing a logistic activation function across the graph model using each vector to determine a baseline engagement and an engagement threshold for each user; and applying a machine learning algorithm to predict engagement movement for each user. In some embodiments, the expert system is part of an expert system network comprising a plurality of expert systems. In further embodiments, the algorithm to analyze interaction patterns operates across the expert system network. In further embodiments, the algorithm to analyze interaction patterns employs longitudinal probabilistic network analysis (PNA) to identify the patterns and trends of dynamics within the expert system network. In further embodiments, the machine learning algorithm predicts engagement movement for each user with one or more of the plurality of expert systems in the expert system network. In various embodiments, the interaction patterns are between users, between users and expert systems, between expert systems, or any combination thereof. In some embodiments, the graph model comprises time-series data. In various embodiments, the pre-selected metrics comprise one or more of: speed of response, conversational sentiment, dialogue complexity, response accuracy, and bounce rate. In some embodiments, the randomized vectorization comprises a combinatorial process. In further embodiments, the combinatorial process comprises partial differentiation. In some embodiments, each vector forms a multi-dimensional point-in-time engagement metric. In some embodiments, the logistic activation function comprises a non-linear function. In some embodiments, the logistic activation function comprises a learned distribution function for overall negative engagement and overall positive engagement. In some embodiments, the method further comprises applying an algorithm to perform a combinatorial analysis of the variables to determine relationships and groupings. In some embodiments, the method further comprises performing a course correction action when the predicted engagement movement is negative. In some embodiments, the method further comprises performing a sustainability action when the predicted engagement movement is positive. In some embodiments, the logistic activation function determines a baseline engagement and an engagement threshold for users in aggregate. In further embodiments, the machine learning algorithm predicts engagement movement for users in aggregate.

In yet another aspect, disclosed herein are computer-implemented systems for predicting expert system user engagement, the system comprising: a pattern interaction module configured to apply an algorithm to analyze interaction patterns in the expert system and develop a graph model; a vectorization module configured to perform randomized vectorization of a plurality of pre-selected metrics, wherein each vector has at least two metrics; a threshold module configured to develop a logistic activation function across the graph model using each vector to determine a baseline engagement and an engagement threshold for each user; and a prediction module configured to apply a machine learning algorithm to predict engagement movement for each user. In some embodiments, the expert system is part of an expert system network comprising a plurality of expert systems. In further embodiments, the algorithm to analyze interaction patterns operates across the expert system network. In further embodiments, the algorithm to analyze interaction patterns employs longitudinal probabilistic network analysis (PNA) to identify the patterns and trends of dynamics within the expert system network. In further embodiments, the machine learning algorithm predicts engagement movement for each user with one or more of the plurality of expert systems in the expert system network. In various embodiments, the interaction patterns are between users, between users and expert systems, between expert systems, or any combination thereof. In some embodiments, the graph model comprises time-series data. In various embodiments, the pre-selected metrics comprise one or more of: speed of response, conversational sentiment, dialogue complexity, response accuracy, and bounce rate. In some embodiments, the randomized vectorization comprises a combinatorial process. In further embodiments, the combinatorial process comprises partial differentiation. In some embodiments, each vector forms a multi-dimensional point-in-time engagement metric. In some embodiments, the logistic activation function comprises a non-linear function. In some embodiments, the logistic activation function comprises a learned distribution function for overall negative engagement and overall positive engagement. In some embodiments, the system further comprises a variable analysis module configured to apply an algorithm to perform a combinatorial analysis of the variables to determine relationships and groupings. In some embodiments, the system further comprises a follow-up action module configured to perform a course correction action when the predicted engagement movement is negative. In some embodiments, the system further comprises a follow-up action module configured to perform a sustainability action when the predicted engagement movement is positive. In some embodiments, the logistic activation function determines a baseline engagement and an engagement threshold for users in aggregate. In further embodiments, the machine learning algorithm predicts engagement movement for users in aggregate.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 shows a non-limiting example of a computing device; in this case, a device with one or more processors, memory, storage, and a network interface;

FIG. 2A shows a non-limiting example of a block diagram; in this case, a diagram illustrating functioning of an exemplary expert system;

FIG. 2B shows a non-limiting example of a block diagram; in this case, a diagram illustrating an architecture of an expert system improvement system;

FIG. 3A shows a non-limiting example of a conceptual diagram; in this case, a diagram demonstrating the development of a point-in-time engagement metric;

FIG. 3B shows a non-limiting example of a conceptual diagram; in this case, a diagram demonstrating the development of a logistic activation function across the graph;

FIG. 3C shows a non-limiting example of a conceptual diagram; in this case, a diagram demonstrating an engagement movement prediction;

FIG. 4 shows a non-limiting example of a conceptual diagram; in this case, a diagram representing an exemplary dialog sequence wherein the subject matter described herein will analyze interaction patterns; and

FIG. 5 shows a non-limiting example of a conceptual diagram; in this case, a diagram illustrating wherein each dialog results in a decomposed ontology (graph) model, wherein vectorization of each graph creates a numerical quantity for ease of comparison, and wherein the subject matter described herein compares disparate models in terms of depth and breadth.

### DETAILED DESCRIPTION

Described herein, in certain embodiments, are computer-implemented systems for predicting expert system user engagement, the system comprising at least one computing device comprising at least one processor and instructions executable by the at least one processor to perform operations comprising: applying an algorithm to analyze interaction patterns in the expert system and develop a graph model; performing randomized vectorization of a plurality of pre-selected metrics, wherein each vector has at least two metrics; developing a logistic activation function across the graph model using each vector to determine a baseline engagement and an engagement threshold for each user; and applying a machine learning algorithm to predict engagement movement for each user.

Also described herein, in certain embodiments, are computer-implemented methods of predicting expert system user engagement, the method comprising: applying an algorithm to analyze interaction patterns in the expert system and develop a graph model; performing randomized vectorization of a plurality of pre-selected metrics, wherein each vector has at least two metrics; developing a logistic activation function across the graph model using each vector to determine a baseline engagement and an engagement threshold for each user; and applying a machine learning algorithm to predict engagement movement for each user.

Also described herein, in certain embodiments, are computer-implemented systems for predicting expert system user engagement, the system comprising: a pattern interaction module configured to apply an algorithm to analyze interaction patterns in the expert system and develop a graph model; a vectorization module configured to perform randomized vectorization of a plurality of pre-selected metrics, wherein each vector has at least two metrics; a threshold module configured to develop a logistic activation function across the graph model using each vector to determine a baseline engagement and an engagement threshold for each user; and a prediction module configured to apply a machine learning algorithm to predict engagement movement for each user.

### Certain Definitions

Unless otherwise defined, all technical terms used herein have the same meaning as commonly understood by one of ordinary skill in the art to which the present subject matter belongs.

As used in this specification and the appended claims, the singular forms “a,” “an,” and “the” include plural references unless the context clearly dictates otherwise. Any reference to “or” herein is intended to encompass “and/or” unless otherwise stated.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

As used herein, “expert system” means any system that can accept a natural language query and provide a response, including by way of non-limiting examples, decision support systems and chatbots.

### Computing System

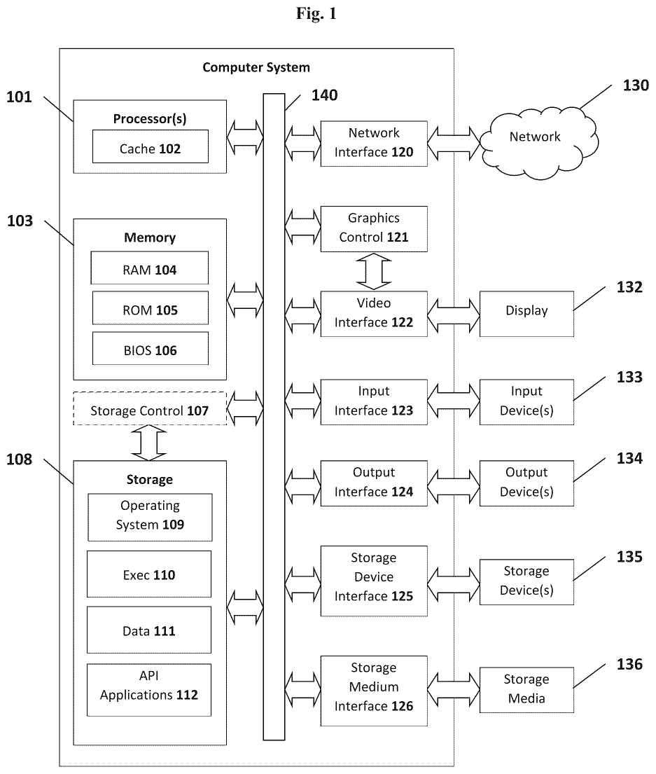

Referring to FIG. 1, a block diagram is shown depicting an exemplary machine that includes a computer system 100 (e.g., a processing or computing system) within which a set of instructions can execute for causing a device to perform or execute any one or more of the aspects and/or methodologies for static code scheduling of the present disclosure. The components in FIG. 1 are examples only and do not limit the scope of use or functionality of any hardware, software, embedded logic component, or a combination of two or more such components implementing particular embodiments.

Computer system 100 may include one or more processors 101, a memory 103, and a storage 108 that communicate with each other, and with other components, via a bus 140. The bus 140 may also link a display 132, one or more input devices 133 (which may, for example, include a keypad, a keyboard, a mouse, a stylus, etc.), one or more output devices 134, one or more storage devices 135, and various tangible storage media 136. All of these elements may interface directly or via one or more interfaces or adaptors to the bus 140. For instance, the various tangible storage media 136 can interface with the bus 140 via storage medium interface 126. Computer system 100 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 100 includes one or more processor(s) 101 (e.g., central processing units (CPUs), general purpose graphics processing units (GPGPUs), or quantum processing units (QPUs)) that carry out functions. Processor(s) 101 optionally contains a cache memory unit 102 for temporary local storage of instructions, data, or computer addresses. Processor(s) 101 are configured to assist in execution of computer readable instructions. Computer system 100 may provide functionality for the components depicted in FIG. 1 as a result of the processor(s) 101 executing non-transitory, processor-executable instructions embodied in one or more tangible computer-readable storage media, such as memory 103, storage 108, storage devices 135, and/or storage medium 136. The computer-readable media may store software that implements particular embodiments, and processor(s) 101 may execute the software. Memory 103 may read the software from one or more other computer-readable media (such as mass storage device(s) 135, 136) or from one or more other sources through a suitable interface, such as network interface 120. The software may cause processor(s) 101 to carry out one or more processes or one or more steps of one or more processes described or illustrated herein. Carrying out such processes or steps may include defining data structures stored in memory 103 and modifying the data structures as directed by the software.

The memory 103 may include various components (e.g., machine readable media) including, but not limited to, a random access memory component (e.g., RAM 104) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 105 may act to communicate data and instructions unidirectionally to processor(s) 101, and RAM 104 may act to communicate data and instructions bidirectionally with processor(s) 101. ROM 105 and RAM 104 may include any suitable tangible computer-readable media described below. In one example, a basic input/output system 106 (BIOS), including basic routines that help to transfer information between elements within computer system 100, such as during start-up, may be stored in the memory 103.

Fixed storage 108 is connected bidirectionally to processor(s) 101, optionally through storage control unit 107. Fixed storage 108 provides additional data storage capacity and may also include any suitable tangible computer-readable media described herein. Storage 108 may be used to store operating system 109, executable(s) 110, data 111, applications 112 (application programs), and the like. Storage 108 can also include an optical disk drive, a solid-state memory device (e.g., flash-based systems), or a combination of any of the above. Information in storage 108 may, in appropriate cases, be incorporated as virtual memory in memory 103.

In one example, storage device(s) 135 may be removably interfaced with computer system 100 (e.g., via an external port connector (not shown)) via a storage device interface 125. Particularly, storage device(s) 135 and an associated machine-readable medium may provide non-volatile and/or volatile storage of machine-readable instructions, data structures, program modules, and/or other data for the computer system 100. In one example, software may reside, completely or partially, within a machine-readable medium on storage device(s) 135. In another example, software may reside, completely or partially, within processor(s) 101.

Bus 140 connects a wide variety of subsystems. Herein, reference to a bus may encompass one or more digital signal lines serving a common function, where appropriate. Bus 140 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 100 may also include an input device 133. In one example, a user of computer system 100 may enter commands and/or other information into computer system 100 via input device(s) 133. Examples of an input device(s) 133 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 133 may be interfaced to bus 140 via any of a variety of input interfaces 123 (e.g., input interface 123) including, but not limited to, serial, parallel, game port, USB, FIREWIRE, THUNDERBOLT, or any combination of the above.

In particular embodiments, when computer system 100 is connected to network 130, computer system 100 may communicate with other devices, specifically mobile devices and enterprise systems, distributed computing systems, cloud storage systems, cloud computing systems, and the like, connected to network 130. Communications to and from computer system 100 may be sent through network interface 120. For example, network interface 120 may receive incoming communications (such as requests or responses from other devices) in the form of one or more packets (such as Internet Protocol (IP) packets) from network 130, and computer system 100 may store the incoming communications in memory 103 for processing. Computer system 100 may similarly store outgoing communications (such as requests or responses to other devices) in the form of one or more packets in memory 103 and communicated to network 130 from network interface 120. Processor(s) 101 may access these communication packets stored in memory 103 for processing.

Examples of the network interface 120 include, but are not limited to, a network interface card, a modem, and any combination thereof. Examples of a network 130 or network segment 130 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 130, may employ a wired and/or a wireless mode of communication. In general, any network topology may be used.

Information and data can be displayed through a display 132. Examples of a display 132 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 132 can interface to the processor(s) 101, memory 103, and fixed storage 108, as well as other devices, such as input device(s) 133, via the bus 140. The display 132 is linked to the bus 140 via a video interface 122, and transport of data between the display 132 and the bus 140 can be controlled via the graphics control 121. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 132, computer system 100 may include one or more other peripheral output devices 134 including, but not limited to, an audio speaker, a printer, a storage device, and any combinations thereof. Such peripheral output devices may be connected to the bus 140 via an output interface 124. Examples of an output interface 124 include, but are not limited to, a serial port, a parallel connection, a USB port, a FIREWIRE port, a THUNDERBOLT port, and any combinations thereof

In addition or as an alternative, computer system 100 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of user, expert system, engagement metric, engagement drop-off, engagement prediction, corrective action, and sustaining action information. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### Technical Overview

The subject matter described herein, in some embodiments, indicates whether the chatbot experience strengthens or weakens existing consumer relationships. In some embodiments, the threshold activation function becomes a classifier for present engagement and a baseline for predicting future engagement. This novel solution, in some embodiments, guides implementation on how best to triage critical resources to triage situations where the engagement prediction is negative and how to sustain and increase positive predictions.

Provided herein is a solution for tracking engagement: 1) A point-in-time engagement metric; 2) A threshold activation function that minimally indicates under-vs-over engagement (e.g., learned distribution function for overall positive or negative engagement); and 3) An engagement movement prediction.

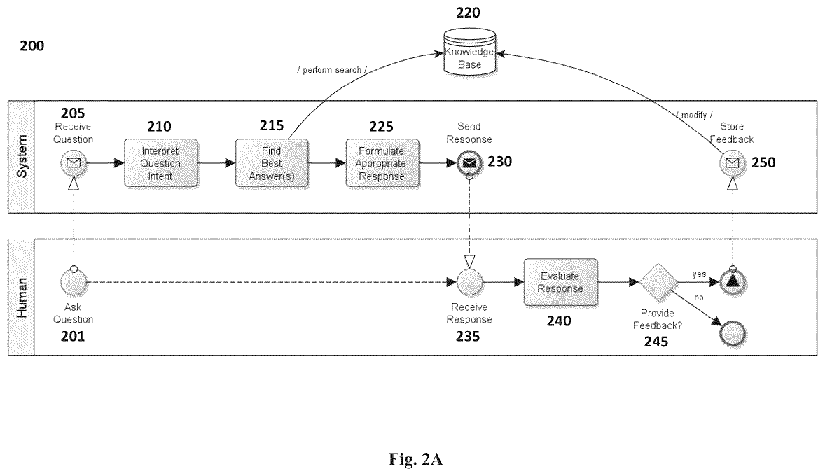

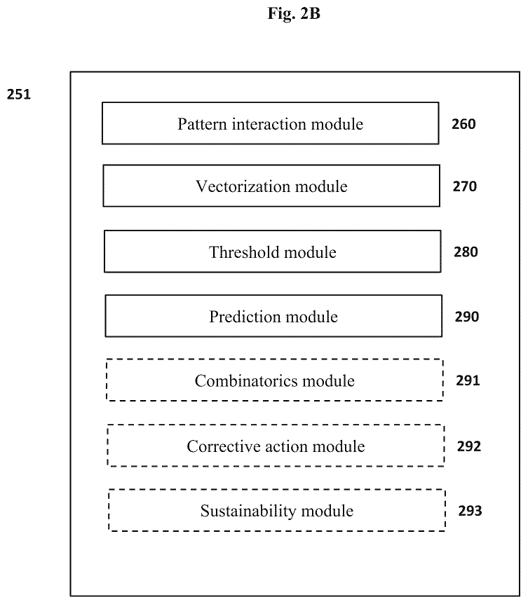

Referring to FIG. 2B, in some embodiments, a system for predicting expert system user engagement 251 described herein comprises a modular architecture. By way of example, in some embodiments, the system comprises a pattern interaction module 260 applying an algorithm to analyze interaction patterns in the expert system and develop a graph model. In some cases, the expert system is part of an expert system network comprising a plurality of expert systems and the algorithm to analyze interaction patterns operates across the expert system network. In various embodiments, the interaction patterns are between users, between users and expert systems, between expert systems, or any combination thereof. In a particular embodiment, the algorithm to analyze interaction patterns employs longitudinal probabilistic network analysis (PNA) to identify the patterns and trends of dynamics within the expert system network. In some embodiments, the graph model developed by analyzing the interaction patterns comprises time-series data. By way of further example, in some embodiments, the system comprises a vectorization module 270 performing randomized vectorization of a plurality of pre-selected metrics, wherein each vector has at least two metrics. In some embodiments, the pre-selected metrics comprise one or more of: speed of response, conversational sentiment, dialogue complexity, response accuracy, and bounce rate. In some embodiments, the randomized vectorization comprises a combinatorial process. In further embodiments, the combinatorial process comprises partial differentiation. In some embodiments, each vector forms a multi-dimensional point-in-time engagement metric. By way of further example, in some embodiments, the system comprises a threshold module 280 developing a logistic activation function across the graph model using each vector to determine a baseline engagement and an engagement threshold for each user. In some embodiments, the logistic activation function comprises a non-linear function. In some embodiments, the logistic activation function comprises a learned distribution function for overall negative engagement and/or overall positive engagement. In some embodiments, the logistic activation function determines a baseline engagement and an engagement threshold for users in aggregate. By way of still further example, in some embodiments, the system comprises a prediction module 290 applying a machine learning algorithm to predict engagement movement for each user. In some embodiments, the machine learning algorithm predicts engagement movement for each user with one or more of the plurality of expert systems in the expert system network. In a particular embodiment, the logistic activation function determines a baseline engagement and an engagement threshold for users in aggregate and the machine learning algorithm predicts engagement movement for users in aggregate.

Continuing to referring to FIG. 2B, in some embodiments, a system for predicting expert system user engagement 200 described herein optionally comprises a combinatorics module 291 applying an algorithm to perform a combinatorial analysis of the variables to determine relationships and groupings. Also, in some embodiments, a system for predicting expert system user engagement 200 described herein optionally comprises a corrective action 292 module performing a course correction action when the predicted engagement movement is negative. Also, in some embodiments, a system for predicting expert system user engagement 200 described herein optionally comprises a sustainability module 293 performing a sustainability action when the predicted engagement movement is positive.

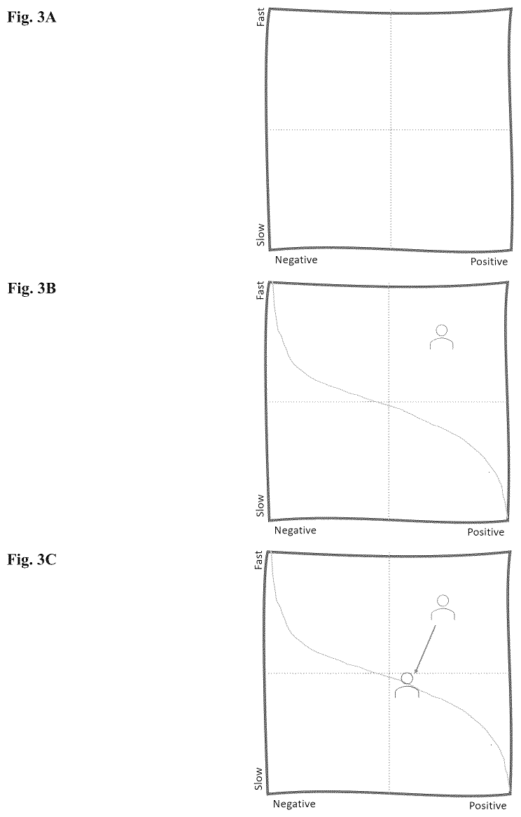

Considering FIGS. 3A-3C, the first diagram, FIG. 3A, demonstrates the development of a point-in-time engagement metric. If this diagram were the sole output of the solution, it would be possible to use this visualization as a “magic quadrant” and classify the consumer engagement level along a multi-dimensional scale, with qualifiable labels such as “highly positive, mostly positive, neutral” and so forth.

The second diagram, FIG. 3B, demonstrates the development of a logistic activation function across the graph. This function is a probabilistic function that reflects the engagement fall-off level. Again, we differentiate against most solutions in this space that use a linear line developed using a straight edge (or a similar heuristic). Furthermore, the consumer is highly engaged in this example, as the depicted icon is above the drop-off threshold.

The third and final diagram, FIG. 3C, demonstrates an engagement movement prediction. Again, the projection reflects the consumer position moving slightly below the drop-off threshold. In this case, the solution postulates via this prediction that while the consumer experience is mainly positive, the engagement will experience a near-term drop-off.

### Exemplary Implementation

We envision environments that, in some embodiments, move beyond simple single-channel and single-bot experiences. Compounded with this increased complexity is the paradigm shift of chatbots becoming increasingly capable of engaging and insightful synthetic speech. In addition, improvements in conversational capabilities are shifting interactions between humans and bots into more extended conversational patterns.

Although, today, it is possible to log onto a website and have a single bot that represents the totality of the brand and attempts to handle all the interactions. We look forward to a near-term point in the industry when a digital doppelganger augments every organizational function.

This technical shift has advantages in terms of more comprehensive and active audience engagement but has a massive downside. An extended conversation, whether between humans or humans and systems, contains banalities, minutia, and repetitious chatter. In addition, existing systems and methods for capturing agent intent are insufficient.

We no longer, in some embodiments, consider the appropriateness of attempting to consolidate all organizational functionality behind a single chatbot. If a consumer has an initial or shallow interaction with an organization—perhaps visiting for the first time at a point in time via a website or virtual room, a concierge or general purpose digital actor can help guide them. But there again, this becomes the introductory facility.

Instead, in some embodiments, we aim at a situation where the human actor is deeply immersed within an organization and needs help navigating the complexity.

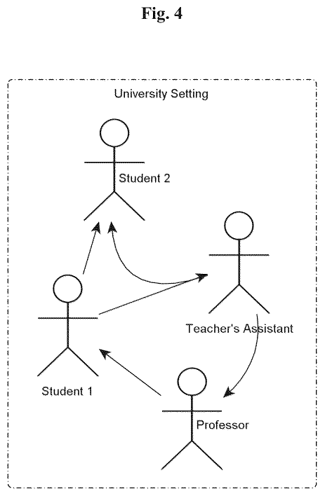

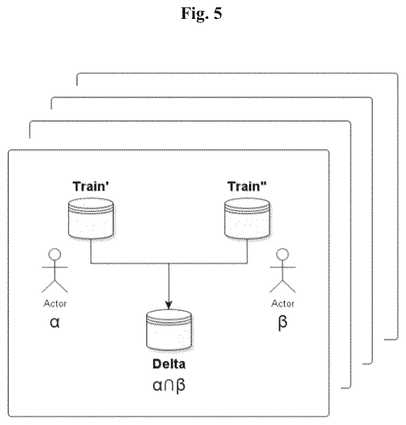

Referring to FIG. 4, by way of non-limiting example, consider a student within a classic academic environment: the University. Within the university, the student may interact with multiple professors. Each professor may have at least one Teaching Assistant (TA). And again, there may be one-or-more libraries, each with one-or-more librarians, each with a digital backup. There are HR and administrative functions and student-life services, all with personalized avatars accessible 24/7/365.

For the extent of this disclosure, we will use a student at a university as our primary use case, but we do not limit ourselves to this as our sole implementation. Likewise, we use the term digital doppelganger with intent. We similarly envision a future when digital entities augment human activity by extrapolating meaning from daily life's banalities, minutia, and repetitious chatter.

Considering the complexity within this scenario, the consideration of an engagement metric and prediction becomes a multi-dimensional complexity.

Recall that FIG. 3A demonstrates the development of a point-in-time engagement metric. This diagram is an effective magic quadrant that can classify engagement levels along a multi-dimensional scale.

Within a chat field of abundant digital persona, the system and method, in some embodiments, perform the following analysis:
Who is interacting with who?
What is the preferred interaction path?
Is there a less efficient but more positive interaction path?

The platforms, systems, media, and methods described herein, in further embodiments, analyze interaction patterns. The algorithm, in some embodiments, employs longitudinal probabilistic network analysis (PNA) to identify the patterns and trends of network dynamics. In such embodiments, a goal is to reveal and quantify indistinct interaction patterns. Hence, using PNA is considered beneficial, in some embodiments, for identifying interaction patterns that can shed light on the dynamics of agent interaction. Therefore, in such embodiments, we define the boundaries of PNA as properly encompassing all agent interactions, whether bot or human.

The first point is the simplest to both gather and analyze. Each interaction between human and human, human and bot, bot and human, and bot and bot is studied. The second point involves an Ontological decomposition of content on a semantic basis. The system will extract entities from the conversation and relationships between these entities. The connections may be latent in the linguistic (grammatical) dependencies, made explicit in a graph ahead of time, or implicit in predictive modeling. We do not claim novelty on this sole point and feel it is sufficient to claim industry expertise on this single point. The third point is more critical to differentiating our method from existing methods.

The following code demonstrates an exemplary approach to implementing the points in this analysis:

```
def expand_state(
  s,
  j,
  visited,
  g_function,
  close_list_anchor,
  close_list_inad,
  open_list,
  back_pointer,
):
  for itera in range(n_heuristic):
    open_list[itera].remove_element(s)
  (x, y) = s
  left = (x − 1, y)
  right = (x + 1, y)
  up = (x, y + 1)
  down = (x, y − 1)
  for neighbours in [left, right, up, down]:
    if neighbours net in blocks:
      if valid(neighbours) and neighbours not in visited;
        visited.add(neighbours)
        back_pointer[neighbours] = −1
        g_function(neighbours) = float(“inf”)
      if valid (neighbours) and g_function[neighbours] > g_function[s] + 1:
        g_function[neighbours] = g_function[s] + 1
        back_pointer[neighbours] = s
        if neighbours not in close_list_anchor:
              open_list[0].put(neighbours, key(neighbours, 0, goal, g_function))
              if neighbours not in close_list_inad:
                for var in range(1, n_heuristic):
                  if key (neighbours, var, goal, g function) <= W2 * key(
                    neighbours, 0, goal, g_function
                  ):
                    open_list[j].put(
                      neighbours, key (neighbours, var, goal, g_function)
                    )
def make_common_ground( ):
  some_list = [ ]
  for x in range(1, 5):
    for y in range(1, 6):
      some_list.append((x, y))
  for x in range(15, 20);
    some_list.append((z, 17))
  for x in range(10, 19);
    for y in range(1, 15):
      some_list.append((x, y))
  # L block
  for x in range(1, 4):
    for y in range(12, 19):
      some_list.append((x, y))
  for x in range(3, 13):
    for y in range(16, 19):
      some_list.append((x, y))
  return some_list
def plot_position(start: TPos, goal: TPos, n_heuristic: int):
  g_function = (start: 0, goal: float (“inf”))
  back_pointer = (start: −1, goal: −1}
  open_list = [ ]
  visited = set( )
  for i in range (n_heuristic):
    open_list.append(PriorityQueue( ))
    open_list[i].put(start, key(start, i, goal, g_function))
  close_list_anchor: list[int] = [ ]
  close_list_inad: list[int] = [ ]
  while open_list[0].minkey( ) < float(“inf”);
  for i in range(1, n_heuristic) :
    # print(open list[0].minkey( ), open list[i].minkey( ))
    if open_list[1].minkey( ) <= W2 * open list[0].minkey( ):
      global t
      t += 1
      if g_function[goal] <= open_list[i].minkey( ):
        if g_function[goal] < float(“inf”);
          do something(back_pointer, goal, start)
      else:
        _, get_s = open_list[i].top_show( )
        visited.add(get s)
        expand_state(
          get_s,
          visited,
          g_function,
          close_list_anchor,
          close_list_inad,
          open_list,
          back_pointer,
        )
        close_list_inad.append(get_s)
    else:
      if g_function[goal] <= open_list[0].minkey( ) :
        if g_function[goal] < float(“inf”) ;
          do_something(back_pointer, goal, start)
      else:
        get_s = open_list[0].top show( )
        visited.add(get_s)
        expand_state(
          get_s,
          0,
          visited,
          g_function,
          close_list_anchor,
          close_list_inad,
          open_list,
          back_pointer,
        )
        close_list_anchor, append(get_s)
for i in range (n − 1, −1, −1):
  for j in range(n) :
    if (j, i) in blocks:
      print(“#”, end=“ ”)
    elif (j, i) in back_pointer:
      if (j, i) == (n − 1, n − 1):
        print (“*”, end=“ ”}
    else:
        print ( “-”, end=“ ”)
  else:
      print ( “*”, end=“ ”)
    if (j, 1) == (0 − 1, n − 1) :
      print ( “ <-- End position”, end=“ ”}
```

Referring to FIG. 5, in some embodiments, each conversation results in a decomposed Ontology (graph) model. The vectorization of each graph creates a numerical quantity for ease of comparison. The system compares disparate models in terms of depth and breadth.

[α∩β¹,α∩β², . . . ,α∩β^{N}]

A graph essentially consists of two portions. First, the taxonomical portion (the parent and child relationships) gives depth to the model. The second portion is the relationships that grant breadth—the relationships model connectivity. Connectivity conveys not only “common sense” connections between taxonomically disparate elements but more subtle connections.

Consider again, the diagram of FIG. 4, which may represent the following exemplary fictitious dialog sequence:
A student (Student 1) first asks a fellow student (Student 2) for help on an assignment
Both students then follow up with the Teaching Assistant (TA).
The TA follows up with the Professor.
The Professor converses with the first student.

Not only are taxonomical depth and topical breadth is taken into consideration, but multiple metrics are analyzed. For simplicity of disclosure, we limit ourselves to Speed of Response, Conversational Sentiment, Conversational Complexity, Conversational Length, and Bounce Rate. However, the method itself has no such limitation. The use of specific metrics is limited only to the data gathered in a well-curated fashion and insofar as the comparison is sensible.

In this example, the algorithm will develop a baseline for all consumers and a customized drop-off threshold for each consumer. The drop-off threshold is a fitted logistic function (such as ReLU or sigmoid) that is a statistically learned response against the input data discussed above.

For example, suppose a conversation has a given intent, and the intent has no realization. In that case, the depth and breadth of the content are considered a scored input that will move the fitted line in such a way to indicate a “drop-off” threshold, meaning the consumer did not find what they wanted and may be less likely to engage in the future. This input helps provide an adequately fitted line.

FIG. 3B shows a fit that resembles a sigmoid function. For example, the consumer may have found the correct information (perhaps represented by positive sentiment), but the speed was slow, which curves the threshold downward.

Likewise, a conversation may be fast but inaccurate or otherwise unhelpful. In both cases, the learned function moves beyond a simple linear fit, which would have a high loss function.

Industry uses the term “signal-to-noise” ratio. Classic conversational systems with a “question-and-answer” implementation can generally find the signal (intent) very quickly. If a user says, “I can't log into to my Outlook please help” the system may classify the intent as “LOST_PASSWORD_OUTLOOK.” Finding the signal in this manner is not challenging.

Consider, however, a long conversation full of trivialities. Where is the signal? What is the intent? Perhaps there are multiple intents. Do these intents relate to each other? And if so, do they resemble a straightforward linear path? Or an acyclic graph? How can the signal be derived out of this increased noise?

A predicted measure may result in the following scenario. The series of interactions the consumer took has resulted in a positive outcome. The conversational analysis was efficient and resulted in accurate information for the consumer's purposes.

However, the consumer interaction has focused on an area that may lead to conversational exploration of a space that does not have the taxonomical depth or semantic breadth to achieve similar outcomes in the future. For example, we may make a comparison during an interview when an applicant can successfully answer questions with relevance. Still, at the same time, develop an intuition that should the line of questioning continue, it will bring the conversation to a point where the applicant can no longer answer capably.

In some embodiments, a goal is to help uncover areas that reveal shortcomings while initially appearing successful. For example, consumer engagement may be increasing in this space and using next-best-topic techniques. The analysis may, for example, conclude that if concentration increases at the predicted rate, the system will begin to fail. Failure is an outcome whereby the consumer metric falls below the activation threshold, as depicted in the diagram. Therefore, the actionable outcome may be to either increase the taxonomical depth and semantic breadth or perform both.

Given knowledge's typically infinite nature, any amount of expansion can occur in a knowledge graph. Our goal is to help triage and prioritize the most critical areas while helping steer a team away from spending resource time and development dollars in knowledge domain development that does not impact customer engagement.

In some embodiments, implementation relies on randomized vectorization of pre-selected metrics such as (but not limited to) Speed of Response, Conversational Sentiment, Dialogue Complexity, Response Accuracy, and Bounce Rate, including combinations thereof. Each vector has at least two metrics. It is possible to use higher-order dimensionality but very complex to visualize. Within the scope of this disclosure, we stick with vectors with only two quantities, but the algorithm is not limited to this extent. Larger vector sizes do not necessarily improve prediction accuracy; the prediction accuracy depends instead on data quality (how well curated the input is) and data quantity (how many instance records exist).

In some embodiments, partial differentiation is used to differentiate the two variables within the input vector:

ƒ(x,y)=xy

Differentiation is a combinatorial process. The algorithm treats each item in the vector as a constant compared to another item. The algorithm will not compare items to themselves. For example, the algorithm may treat accuracy as a constant relative to changes in sentiment.

In such embodiments, the derived outcome will measure the rate of change of this function

f(accuracy,sentiment)=(accuracy,sentiment)
concerning a change in the input variable:

$$\frac{\partial accuracy}{\partial sentiment}$$

So, for example, if accuracy is constant but sentiment increases positively, the outcome may be pressed visually as a corresponding shift in the magic quadrant.

In some embodiments, the method continues by taking each partial derivative outcome and storing this within a gradient vector. Thus, the development of the first phase of the process is a gradient vector that contains all the first-order partial derivatives of a function.

The gradient is denoted as

$$∇ f = 〈 \frac{\partial f}{\partial x} , \frac{\partial f}{\partial y} 〉$$

The outcome of this formula become the gradient vector for function ƒ.
After partially differentiating, the system derives

∇ƒ= [symbol] y,x

[symbol]

The purpose of the gradient vector is to point in the direction of the most significant increase. Regarding the terminology in gradient vector analytics, the notion of “increase” may not correspond to a positive outcome in a magic quadrant. The result can likewise mean a change in the direction past the logistic threshold.

In some embodiments, the system computes the gradient vector and iteratively updates the inputs by computing the gradient and adding those values to the previous information. A positive gradient vector will point toward the most significant increase. A negative gradient vector will point toward the most significant decrease.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

What is claimed is:

1. A computer-implemented system for predicting expert system user engagement, the system comprising at least one computing device comprising at least one processor and instructions executable by the at least one processor to perform operations comprising:
a) applying an algorithm to analyze interaction patterns in the expert system and develop a graph model;
b) performing randomized vectorization of a plurality of pre-selected metrics, wherein each vector has at least two metrics;
c) developing a logistic activation function across the graph model using each vector to determine a baseline engagement and an engagement threshold for each user; and
d) applying a machine learning algorithm to predict engagement movement for each user.

2. The system of claim 1, wherein the expert system is part of an expert system network comprising a plurality of expert systems.

3. The system of claim 2, wherein the algorithm to analyze interaction patterns operates across the expert system network.

4. The system of claim 3, wherein the algorithm to analyze interaction patterns employs longitudinal probabilistic network analysis (PNA) to identify the patterns and trends of dynamics within the expert system network.

5. The system of claim 3, wherein the machine learning algorithm predicts engagement movement for each user with one or more of the plurality of expert systems in the expert system network.

6. The system of claim 1, wherein the interaction patterns are between users, between users and expert systems, between expert systems, or any combination thereof.

7. The system of claim 1, wherein the graph model comprises time-series data.

8. The system of claim 1, wherein the pre-selected metrics comprise one or more of: speed of response, conversational sentiment, dialogue complexity, response accuracy, and bounce rate.

9. The system of claim 1, wherein the randomized vectorization comprises a combinatorial process.

10. The system of claim 9, wherein the combinatorial process comprises partial differentiation.

11. The system of claim 1, wherein each vector forms a multi-dimensional point-in-time engagement metric.

12. The system of claim 1, wherein the logistic activation function comprises a non-linear function.

13. The system of claim 1, wherein the logistic activation function comprises a learned distribution function for overall negative engagement and overall positive engagement.

14. The system of claim 1, wherein the operations further comprise applying an algorithm to perform a combinatorial analysis of the variables to determine relationships and groupings.

15. The system of claim 1, wherein the operations further comprise performing a course correction action when the predicted engagement movement is negative.

16. The system of claim 1, wherein the operations further comprise performing a sustainability action when the predicted engagement movement is positive.

17. The system of claim 1, wherein the logistic activation function determines a baseline engagement and an engagement threshold for users in aggregate.

18. The system of claim 17, wherein the machine learning algorithm predicts engagement movement for users in aggregate.

19. A computer-implemented method of predicting expert system user engagement, the method comprising:
a) applying an algorithm to analyze interaction patterns in the expert system and develop a graph model;
b) performing randomized vectorization of a plurality of pre-selected metrics, wherein each vector has at least two metrics;
c) developing a logistic activation function across the graph model using each vector to determine a baseline engagement and an engagement threshold for each user; and
d) applying a machine learning algorithm to predict engagement movement for each user.

20. A computer-implemented system for predicting expert system user engagement, the system comprising:
a) a pattern interaction module applying an algorithm to analyze interaction patterns in the expert system and develop a graph model;
b) a vectorization module performing randomized vectorization of a plurality of pre-selected metrics, wherein each vector has at least two metrics;
c) a threshold module developing a logistic activation function across the graph model using each vector to determine a baseline engagement and an engagement threshold for each user; and
d) a prediction module applying a machine learning algorithm to predict engagement movement for each user.
